(19) United States
(12) Patent Application Publication
(10) Pub. No.: US 2010/0032325 A1
(43) Pub. Date: Feb. 11, 2010

(54) MEDIA DISC STORAGE CONTAINER

(75) Inventor: Tino Solling, Karlslunde (DK)

Correspondence Address: SUGHRUE MION, PLLC, 2100 PENNSYLVANIA AVENUE, N.W., SUITE 800, WASHINGTON, DC, 20037, US

(73) Assignee: SCANAVO A/S, TAASTRUP (DK)

(21) Appl. No.: 12/375,649

(22) PCT Filed: Jul. 26, 2007
(86) PCT No.: PCT/DK07/50102

§ 371 Date: Feb. 23, 2009

(30) Foreign Application Priority Data
Jul. 31, 2006 (DK) PA 2006 01022

(51) Int. Cl. G11B 33/04

(52) U.S. Cl. 206/308.1

(57) ABSTRACT

A media disc storage container comprises a body portion having a front part interconnected with a back part via a hinge part, with hinge part is integral with the front part and the back part along their joining edge portions formed of flexible material. The body portion is composed of at least a coloured material forming one or more coloured portion(s) and a second material, which is more transparent than the coloured material and forms one or more at least partially transparent portion(s). Graphics on a sheet are visible through said at least partially transparent portion(s).

The present invention relates to a media disc storage container comprising a body portion having a front part interconnected with a back part via a hinge part, with hinge part is integral with the front part and the back part along their joining edge portions formed of flexible material, the front part and the back part having first side walls at their edges remote from and parallel to the hinge portion and second side walls and third side walls at their edges extending from the hinge portion to the first side walls, the container preferably further comprising a sheet containing graphics.

The assortment of media discs storage containers is enormous, and producers need to have distinct containers for their media discs to stand out in the myriad of containers in shops. In new product lines it is a desire that the container is used also for indicating the type of media disk held in the container. One and the same game or movie is available on disks for different platforms, and the consumer is assisted in correctly choosing the disk from the product line corresponding to consumer's own equipment when the containers clearly signal the platform type to the consumer.

A container of the first-mentioned type is known from EP-B1-1 258 002, which discloses a container where the printed sheet is secured to the body portion along an edge remote from and parallel to the hinge and extends unsecured across the hinge to the other section where it is secured along an edge remote from and parallel to the hinge. The printed matter may be arranged to be visible at both sides, i.e. its external side visible from the exterior of the container and its internal side visible from the interior of the container through part of the body portion.

WO 96/35628 relates to a composite container for compact discs. This container comprises lightweight frame for storing the disc. The frame is encompassed by a sheath, which is securely bonded to an exterior surface of the frame. Graphics for the package are printed directly on the inside and outside of the sheath. The graphics may be seen from inside the container through an opening in the frame.

In U.S. Pat. No. 5,207,717 a holder for storing a variety of materials, such as compact discs, laser discs, cassettes, pictorial and message displays, is described. The holder includes an elongated spine integrally formed with foldable flaps on opposite edges of the spine. Each flap includes pockets for receiving recorded and printed material.

An object of the invention is to provide a media disc storage container, which is capable of signalling the relevant product line to the consumer and yet provides a distinct presentation of printed graphics relevant to the contents of the disk in the container.

In view of this the initially mentioned media disc storage container is characterized in that the body portion is composed of at least a coloured material forming one or more coloured portion(s) and a second material, which is more transparent than the coloured material and forms one or more at least partially transparent portion(s), and where said sheet, when present, is mounted so that the graphics on the sheet are visible through said at least partially transparent portion(s).

By making the body portion of two different materials where one is coloured and the other is transparent it is possible on the one hand to use the advantages of communicating to the consumer the product line pertaining to the disk in the container and on the other hand to present the graphics clearly and without colour distortion because the graphics are viewed through the second material which is more transparent than the coloured portion. The media disc storage container can be manufactured and sold to a party who fills the containers with the disks containing particular games, software or movies and mounts the sheets with the graphics pertaining to the content of the disks, or the containers can at manufacture be provided with the sheet with the particular graphics. In both cases the result is a media disk container which is highly attractive to the consumer. The container also brings the additional advantage to the consumer that sorting and listing of different types of media discs is facilitated because a particular colour is used as a mark of a certain type of media disc.

In a preferred embodiment the front part has one at least partially transparent portion, which substantially forms a quadrangle and is bordered by the coloured material at least along the second side wall where the front part has a first margin portion of coloured material, and preferably also along the first side wall and the third side wall. In this embodiment the preferred size and form of the sheet, when mounted in the container, is equal to or larger than the quadrangle form of the at least partially transparent portion. If the sheet covers a larger area, the graphics on the sheet is preferably located within the area equal to said quadrangle in order to obtain the distinct presentation and clear view of the printed graphics.

The preferred embodiment can be further developed in that the back part has one at least partially transparent portion, which substantially forms a quadrangle and is bordered by the coloured material at least along the second side wall where the back part has a first margin portion of coloured material, and preferably also along the first side wall and the third side wall. In this embodiment the body portion comprises two at least partially transparent portions shaped as quadrangles: one in the front part and one in the back part. Said two quadrangles may be of the same size or the sizes may be different. Furthermore, in this embodiment one or two sheets may be mounted in the container. If two sheets are to be mounted, the preferred size and form of each sheet is equal to or larger than the size of the respective quadrangles of the at least partially transparent portions through which the graphics of the sheets are visible. If only one sheet is to be mounted, the preferred size and form of said sheet is sufficiently large to cover both quadrangles. However, the graphics on said single sheet must be located in such a way as to be visible through said at least partially transparent portions after mounting.

In a further embodiment the hinge part has one at least partially transparent portion, which forms a quadrangle and which forms a quadrangle and extends between side wall parts of the coloured material. Hence, by introducing this at least partially transparent portion also in the hinge part the body portion can be manufactured with one, two or three continuous areas of the second material. When only one continuous area is present, this area is preferably covering a quadrangle of the front part together with a quadrangle of the hinge part and the back part. This embodiment is the most preferred because the sheet can then extend uninterrupted from the front part to the back part across the hinge part. When two continuous areas are present, these areas may cover: a) one continuous quadrangle covering a quadrangle on the front part together with a quadrangle on the hinge part, the quadrangle of the hinge part being separated by a portion of coloured material along the joining edge between the hinge part and the back part, or b) one quadrangle of the front part and one quadrangle of the hinge part, which are separated by a portion of coloured material along the joining edge between the hinge part and the front part and back part, respectively. Finally, when three areas are present, these areas cover one quadrangle on each of the front part, the back part and the hinge part.

It is possible to have two or more at least partially transparent portions in the front part and/or the back part and/or the hinge part producing a variety of body portions having different numbers of at least partially transparent portions. The size as well as the shape of the at least partially transparent portions may be varied. Instead of a quadrangular shape the at least partially transparent portion(s) can have curved edges, circular or part-circular edges, star-shaped edges or edges of any other geometry. It is, however, preferred that the transparent portion constitutes only a single, coherent area that spans the front part, the hinge part and the back part and is located at a first distance from the first side walls, a second distance from the second side walls, and a third distance from the third side walls, and even more preferred that the second distance is larger than the first distance and larger than the third distance.

The width of the margin portions of coloured material may also vary to a great extent. Preferably, all first margin portions along the second side walls and along the back part are of identical width and all margins portions along the third side walls and the back part are of identical width. In a preferred embodiment the width of the first margin portions are larger than the width of all other margin portions. It is furthermore preferred that the width of the margin portions along the first side walls is of the same size as the width of the margin portions along the first side walls.

The body portion of the media disc storage container may be made of any suitable materials, as long as the joining edge portions to the hinge part are formed of flexible material. However, it is a characteristic feature of the present invention that the second material must be more transparent than the coloured material. A suitable material is polypropylene due to its high strength, its ability to flex without breaking, high heat resistance and outstanding crack resistance. Consequently, the body portion is preferably made with the second material of a non-dyed polypropylene and the coloured material of a dyed polypropylene. One advantage of using polypropylene for both materials is the ease by which they can be joined. When the container is made by injection moulding the two materials will bind to one another, also when the binding area is relatively thin because the front part, the back part or the hinge part has a small wall thickness. Another suitable material to be used as the second material is polystyrene or polycarbonate due to its excellent clarity (almost fully transparent). Hence, in a preferred embodiment the second material of the body portion is polystyrene or polycarbonate.

In a particular embodiment of the container a protrusion is provided at the interface between the second material and the coloured material. The protrusion may consist of either the second material or the coloured material, or a blend of the two materials. The height and the width may vary to the extent, which is obvious for skilled person.

In an embodiment the coloured material and the second material have been united so that one of the two materials overlap the other of the two materials in the joining area. This embodiment facilitates the manufacture of the container in a manner that produces a comparatively sharp and uniform transition from the one material to the other. The one material may e.g. be injection moulded in a mould creating a bevelled edge at the joining area, and then one of the mould parts can be exchanged with another and the other material can be injection moulded to form a complete container. The bevelled joining faces increases the contact area between the two materials, and thus provides a very secure joint between the materials when the wall thickness is diminutive.

In a preferred embodiment the two materials do generally not overlap, except in areas located at the injection points. Preferably, two incection points are used when effecting the injection moulding, which injection points are located at either end of the back part, viz at the end facing the second side walls and the opposite end facing the third side walls on the front and back parts.

The media disc storage container may additionally on the outside of the container comprise a plastic film, which is attached to the front part and the back part at least along the first side walls, and forms a sleeve for receiving the sheet. The sheet may then be inserted behind the film in the sleeve. If graphics are printed on both sides of the sheet, this combination provides the graphics to be visible from outside the container through the transparent plastic film as well as from inside the container through the at least partially transparent portion(s). The number, size and form of the sheet is determined by the number, size and location of the at least partly transparent portion(s) of the body portion as discussed above, and preferably only a single sheet is used.

Alternatively, the media disc storage container may comprise an at least partially transparent lining part on the inside of the container. At the mounting the sheet is sandwiched between a part of the body portion and said at least partially transparent lining part. If graphics are printed on both sides of the sheet, said graphics are visible from outside as well as from inside the container. The number, size and form of the sheet is determined by the number, size and location of the at least partly transparent portion(s) of the body portion as discussed above.

In yet another alternative embodiment the sheet may be secured to the inside of the body portion, such as by in-mould labelling. Also in this embodiment the graphics of the sheet is visible from outside as well as from inside the container. The number, size and form of the sheet is determined by the number, size and location of the at least partly transparent portion(s) of the body portion as discussed above.

Panels may optionally be incorporated into the first side walls of the media disc storage container. These panels may be made of the same or of a different material than the rest of the body portion of the container. Furthermore, the material may be transparent or non-transparent and may be of any colour. The panels may provide surfaces that are suitable for gripping by fingers when the container is to be opened. The panels can consequently be of a material having surface properties providing relatively high friction, or a more soft surface than the other parts in order to provide a pleasant grip.

In a further embodiment the dye of the coloured material is selected from the group consisting of blue dyes or red dyes. These colours provide the container with a very distinct look, because they are colours to which the eye is attracted. They also bring the distinct advantage that the joining areas between the second material and the coloured material are easy to manufacture in a neat manner because the contrast between these colours and the second material is high, in particular when the second material is of non-dyed polypropylene. Other dyes like yellow dyes, orange dyes, or green or other mixed colour dyes are also possible, but not preferred.

A person skilled in the art will recognise that the media disc storage container may further comprise means for fastening the media disk or media disks in the container, such as rosettes, stumps, clamping fingers, hubs, engagement means for fixing the disk at its periphery, and the like. The drafting, location and mounting of such fastening means lie within the skills of an ordinary practitioner.

It is well known that media disc storage containers often comprises means for inserting information sheets, advertising material or other loose leaves. A skilled person would know how to incorporate such means into a container according to the present invention. Furthermore, the inclusion of such loose leaves into the media disc storage container lies within the scope of the present invention.

In the following the invention will be described in more detail by way of example and with reference to the drawing, in which:

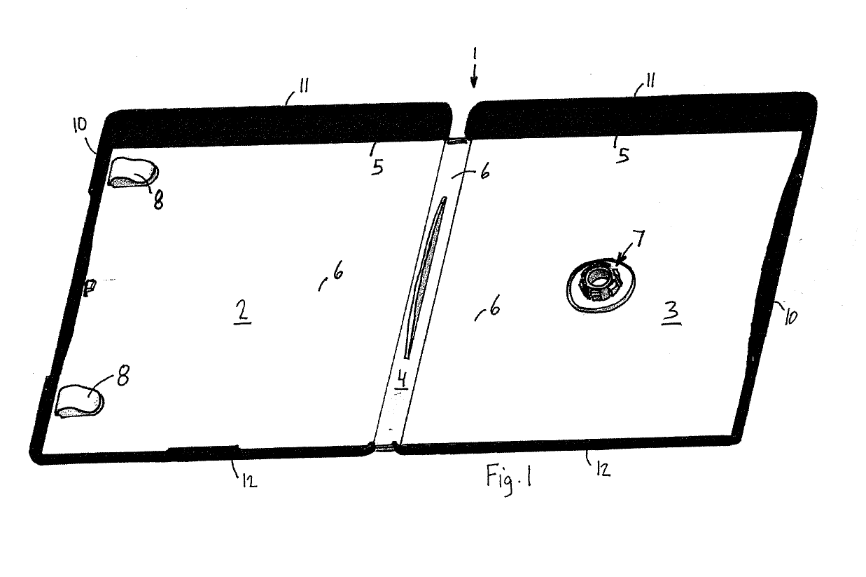

FIG. 1 is a view of an open media disc storage container according to the invention seen from the inside and with coloured indication of the coloured portions,

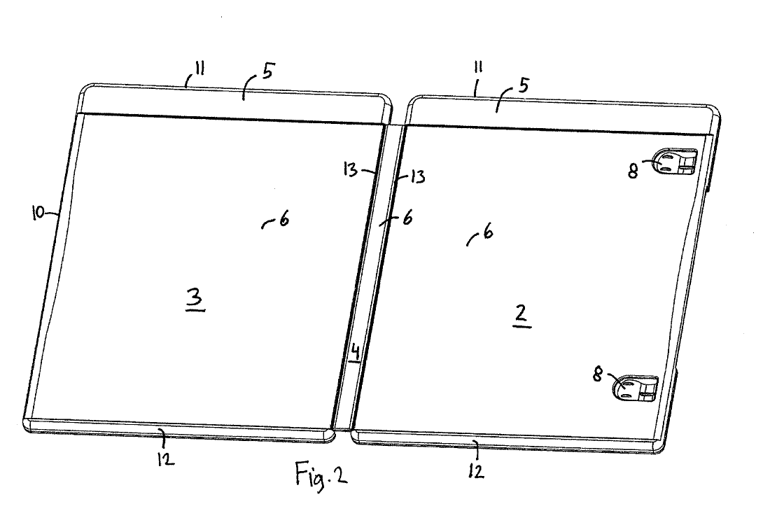

FIG. 2 is a view of an open media disc storage container according to the invention seen from the outside,

FIG. 3 is a view of an open media disc storage container according to the invention seen from the inside,

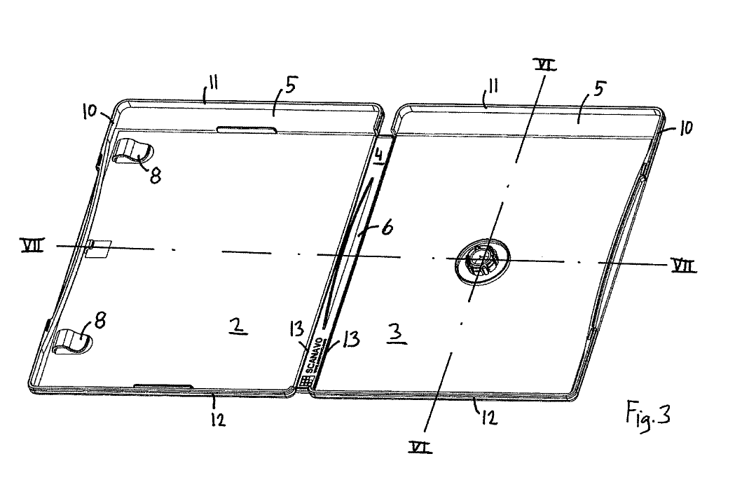

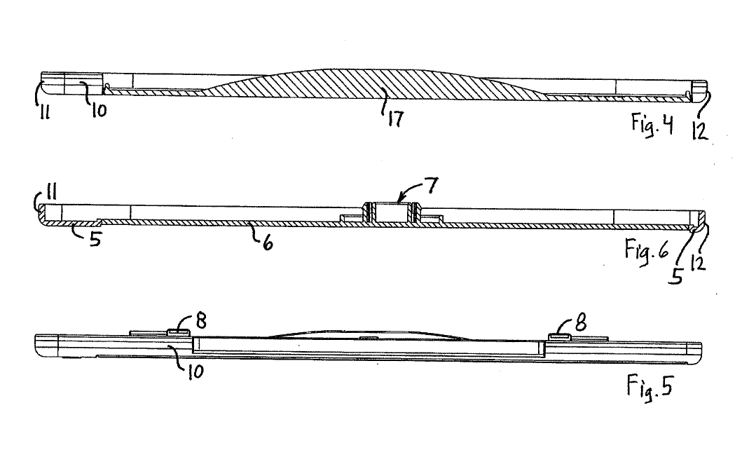

FIG. 4 is a side view of the open container showing the first side wall,

FIG. 5 is a side view of the open container showing the first wall connected to the front part,

FIG. 6 is a cross-sectional view along the line VI-VI in FIG. 3,

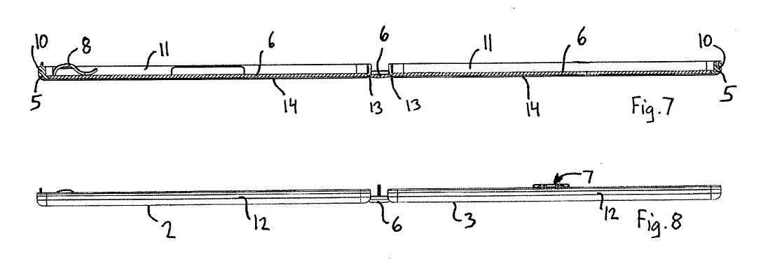

FIG. 7 is a cross sectional view along the line VII-VII in FIG. 3,

FIG. 8 is a side view of the open container showing the second side wall,

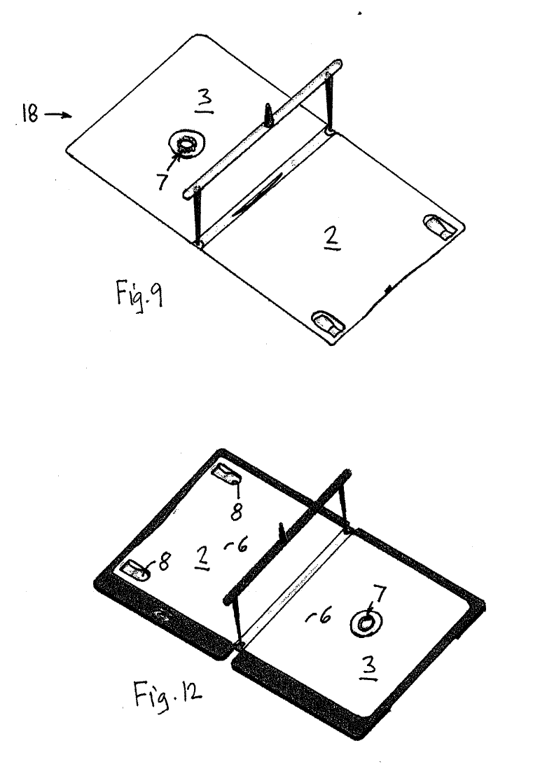

FIG. 9 illustrates the transparent portion of the second material immediately after moulding, together with an indication of the injection points,

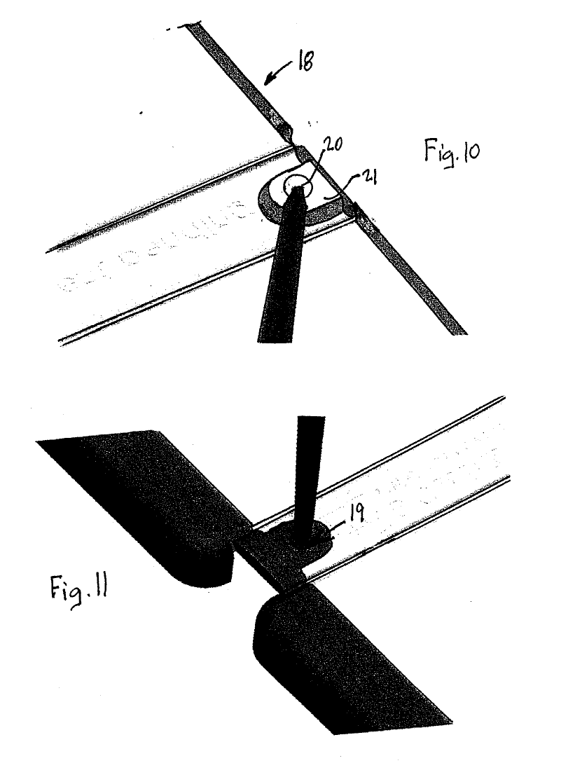

FIG. 10 illustrates one of the injection points for the second material,

FIG. 11 illustrates the same injection point as in FIG. 10 at the end of injecting the coloured material,

FIG. 12 illustrates the container immediately after moulding the coloured portion of coloured material, together with an indication of the injection points for the coloured material, and

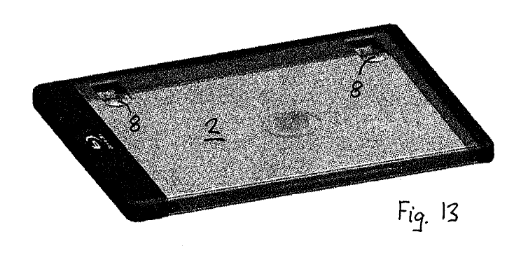

FIG. 13 illustrates the moulded container in closed state before mounting of a sheet containing graphics.

FIGS. 1-3 depict a media disc storage container according to the invention seen from the inside in an open state. The container comprises a body portion generally designated 1 and including a front part 2 and a back part 3 interconnected by a hinge part 4. The front part has a first side wall 10 extending along the edge remote from and parallel to the hinge portion, and the back part 3 also has a first side wall 10 extending along the edge remote from and parallel to the hinge portion, and the two first side walls 10 cooperate to form a closed side wall when the container is in the closed state. The first side wall is provided with engagement means that can engage to keep the container in the closed state.

The front part has a second side wall 11 along the edge which is intended to be the upper edge of the container, when it is hanging in display in a store, and a third side wall 12 at the opposite edge. The second side wall and the third side wall extend from the hinge portion to the first side wall. The back part 3 is provided with a similar second side wall 11 and a similar third side wall 12.

The side walls are of a coloured material forming coloured portions, and the front part 2 and the back part 3 have along the second side walls a first margin portion 5 which is also of the coloured material and the margin portions are integral with the associated second side walls.

The front part 2 and the back part have also transparent portions 6 of a second material, which is more transparent than the coloured material. The individual transparent portion 6 extends from the area next to the third side wall 12 to the first margin portion 5 in the a direction parallel to the hinge part and from the first side wall 10 to the hinge part 4 in a direction being transverse to the first-mentioned direction. A sheet may be mounted in the container in a manner making the graphics on the sheet visible through the at least partially transparent portions 6.

The hinge part 4 is made of the second material and forms an at least partially transparent portion 6 which is integral with the portions 6 in the front part 2 and the back part 3. The second side walls and the third side walls turn around the corners of the front part 2 and the back part 3 and extend a short distance in direction of a centre line in the container so that they terminate at the portion 6 of the hinge part.

In the embodiment of the container illustrated in FIGS. 1-3 the at least partially transparent portions 6 form a single continuous area made up of three quadrangles. Two of said quadrangles are located in the front part 2 and in the back part 3, and one quadrangle in the hinge part 4. The quadrangles need not be true quadrangles with four straight edges, as the quadrangles in the front part 2 and the back part 3 have a somewhat curved edge along the first side walls 10. And the quadrangles on the front part and the back part may have rounded corners at the side facing the first side walls. The quadrangles are however substantially quadrangular.

FIGS. 4 and 5 illustrate in an enlarged view the first side walls 10, which are designed with a recessed area for providing access for fingers when the container is to be opened.

FIGS. 6 and 7 show the extent of the at least partially transparent portions 6 and also the extent of the coloured portions 5. In this embodiment there is no overlap in the joining faces, as the joining faces extend transversely to the outside surface of the transparent portion 6. In the area of the hinge part the at least partially transparent portions 6 are mutually integral as joining edge portions 13 formed of flexible material connect the front part 2 and the back part 3 with the hinge part along the complete length of the hinge part.

The front part and the back part are on their outside provided with a plastic film 14 which forms a pocket for receiving a sheet with printing. The sheet is mounted in a manner making the graphics on the sheet visible through said at least partially transparent portions. The sheet can be slightly larger than the transparent portions so that the coloured material extends past the edge portions of the sheet when the latter is in mounted position in the pocket.

The container according to the invention may comprise further components. For example FIGS. 1 and 7 illustrate clips 8 for holding information material provided together with the disk, and a disk holder shaped as a hub 7 in form of a rosette is provided on the back part.

However, the disk or disks may alternatively be fixed in the container by other fastening means, such as stumps, clamping fingers, grooves receiving the edge portion of the disk so that it is held at the periphery without any fixing at the central portion of the disk.

The container according to the invention may also comprise panels like the panel 17 illustrated in FIG. 4. Such panels make it easier to open the container, and it constitutes a detail, which makes the container more distinguishable from other containers on the market.

The injection moulding of the container is now described in further detail. Injection moulding of media disc storage containers is a well known technique when the container is made of a single uniform material, so the following description is directed at the features for injection moulding the container in two materials. The materials are preferably of the same type, but have different transparency due to colouring of at least one of the materials.

The first part of the container to be injection moulded is transparent part 18. The mould used has a movable mould part, and a first stationary mould part and a second stationary mould part. When the movable mould part is closed onto the first stationary mould part the space within the mould corresponds to the shape of the transparent part 18 of the container. And when the movable mould part is closed onto the second stationary mould part the space within the mould corresponds to the shape of the complete container. The movable mould part maintains a grip in the transparent part 18 of the container when the movable mould part is moved from the first stationary mould part to the second stationary mould part, so that the transparent part 18 of the container is located within the space in the mould before the coloured material is injected into the mould. The free space within the mould thus corresponds to the volume to be filled with the coloured material.

Injection points 19 for the coloured material are located at the injection points 20 for the transparent material. This is illustrated in detail in FIGS. 10 and 11. The first part has a recess 21 surrounding injections point 20. When the movable mould part has placed transparent part 18 in the second stationary mould part, the recess 21 is facing the injection point for coloured material and provides a flow path for coloured material from the injection point into the space to be filled with that material.

After injecting the second material for moulding the transparent part 18 the movable mould part is maintained in contact with the first stationary mould part for a short period, such as from 1 to 5 seconds, preferably from 2 to 3 seconds, in order to cool transparent part 18 sufficiently for it to be moved away from the first stationary mould part, and then the mould is opened, and the movable mould part moves the transparent part 18 into the second stationary mould part where the coloured material is injected. During this movement the transparent part is turned with the result that the two injections are performed from opposite sides of the transparent part. After another short period, such as from 1 to 5 seconds, preferably from 2 to 3 seconds, the mould is opened and the moulded container is ejected.

The moulding procedure in two consecutive injection procedures is efficient, and at the time of injection of the coloured material the transparent part is at elevated temperature caused by the just finished first injection procedure. As the hot coloured material contacts the second material along the edges of the transparent part the two materials join. It is naturally also possible to injection mould the transparent part in a completely separate procedure, and to warm it before the coloured material is injection moulded, but this is not a preferred procedure, because it is less simple than performing the injection moulding as described in the above. It is furthermore possible to injection mould the coloured material in a first stage followed by injection moulding of the second material.

Modifications to the shape of the container are possible within the scope of the patent claims. As mentioned the hub can be dispensed with when the disk or disks are held at periphery thereof instead at in the centre of the centre of the disk, and if the clips are not required they can also be dispensed with. It is also possible to provide the container with further details that described in the above, such as with protruding parts located at the inside of the hinge part 4 in end areas thereof, which parts can assist in maintaining the correct shape of the hinge part in relation to the front part and the back part when the container is to be closed. In case the disk is fixed in the box by interaction with the centre opening in the disk, then hub 7 can be designed in other shapes than illustrated by the detailed example of an embodiment shown on the drawings.

1-14. (canceled)

15. Media disc storage container comprising a body portion having a front part interconnected with a back part via a hinge part, with hinge part is integral with the front part and the back part along their joining edge portions formed of flexible material, the front part and the back part having first side walls at their edges remote from and parallel to the hinge portion and second side walls and third side walls at their edges extending from the hinge portion to the first side walls, the container further comprising a sheet containing graphics, wherein the body portion is composed of at least a coloured material forming at least one coloured portion and a second material, which is more transparent than the coloured material and forms one or more at least partially transparent portion, and wherein said sheet is mounted so that the graphics on the sheet are visible through said at least partially transparent portion.

16. Media disc storage container as claimed in claim 15, wherein the front part has one at least partially transparent portion, which substantially forms a quadrangle and is bordered by the coloured material at least along the second side wall where the front part has a first margin portion of coloured material.

17. Media disc storage container as claimed in claim 16, wherein the at least partially transparent portion on the front part is bordered by the coloured material along the first side wall and the third side wall.

18. Media disc storage container as claimed in claim 16, wherein the back part has one at least partially transparent portion, which substantially forms a quadrangle and is bordered by the coloured material at least along the second side wall where the back part has a first margin portion of coloured material.

19. Media disc storage container as claimed in claim 18, wherein the at least partially transparent portion on the back part is bordered by the coloured material along the first side wall and the third side wall.

20. Media disc storage container as claimed in claim 16, wherein the hinge part has one at least partially transparent portion, which forms a quadrangle and extends between side wall parts of the coloured material.

21. Media disc storage container as claimed in claim 19, wherein the hinge part has one at least partially transparent portion, which forms a quadrangle and extends between side wall parts of the coloured material.

22. Media disc storage container as claimed in claim 15, wherein the second material is a non-dyed polypropylene and the coloured material is a dyed polypropylene.

23. Media disc storage container as claimed in claim 15, wherein the second material is polycarbonate or polystyrene, and the coloured material is a dyed polypropylene.

24. Media disc storage container as claimed in claim 15, wherein a protrusion is provided at the interface between the second material and the coloured material.

25. Media disc storage container as claimed in claim 24, wherein the protrusion is of either the second material or the coloured material.

26. Media disc storage container as claimed in claim 15, wherein the coloured material and the second material have been united so that one of the two materials overlap the other of the two materials in the joining area.

27. Media disc storage container as claimed in claim 15, wherein the container on the outside further comprises a plastic film, which is attached to the front part and the back part at least along the first side walls, and forms a sleeve for receiving the sheet.

28. Media disc storage container as claimed in claim 15, wherein the container on the inside further comprises an at least partially transparent lining part, and where the sheet is sandwiched between a part of the body portion and said at least partially transparent lining part.

29. Media disc storage container as claimed in claim 15, wherein the sheet is secured to the inside of the body portion, such as by in-mould labelling.

30. Media disc storage container as claimed in claim 15, wherein the dye of the coloured material is selected from the group consisting of blue dyes or red dyes.

31. Media disc storage container as claimed in claim 17, wherein the dye of the coloured material is selected from the group consisting of blue dyes or red dyes.

32. Media disc storage container as claimed in claim 19, wherein the dye of the coloured material is selected from the group consisting of blue dyes or red dyes.

33. Media disc storage container as claimed in claim 22, wherein the dye of the coloured material is selected from the group consisting of blue dyes or red dyes.

34. Media disc storage container as claimed in claim 15, wherein on the outsides of the front part and the back part the partially transparent portion is recessed in relation to the coloured portions.

35. Media disc storage container as claimed in claim 15, wherein the coloured material of the at least one coloured portion and the second material of the one or more at least partially transparent portion(s) cover the entire front part without holes in the material.

36. Media disc storage container as claimed in claim 15, wherein the coloured material of the at least one coloured portion and the second material of the one or more at least partially transparent portion cover the entire back part without holes in the material.

37. Media disc storage container as claimed in claim 35, wherein the coloured material of the at least one coloured portion and the second material of the one or more at least partially transparent portion cover the entire back part without holes in the material.

38. Media disc storage container comprising a body portion having a front part interconnected with a back part via a hinge part, with hinge part is integral with the front part and the back part along their joining edge portions formed of flexible material, the front part and the back part having first side walls at their edges remote from and parallel to the hinge portion and second side walls and third side walls at their edges extending from the hinge portion to the first side walls, wherein the body portion is composed of at least a coloured material forming at least one coloured portion including a first margin portion of the front part along the second side wall, and which body portion has one or more at least partially transparent portion of a second material, which is more transparent than the coloured material, wherein the first margin portion is on the front part and the back part along the second side walls, and wherein both the front part and the back part have one at least partially transparent portion, which substantially forms a quadrangle and is bordered by the coloured material at least along the first margin portion of coloured material.

39. Media disc storage container as claimed in claim 38, wherein the dye of the coloured material is selected from the group consisting of blue dyes or red dyes.

40. Media disc storage container as claimed in claim 38, wherein the dye of the coloured material is selected from the group consisting of blue dyes or red dyes.

41. Media disc storage container as claimed in claim 40, wherein the dye of the coloured material is selected from the group consisting of blue dyes or red dyes.

42. Media disc storage container as claimed in claim 38, wherein the container comprising a sheet containing graphics, which sheet is mounted so that the graphics on the sheet are visible through said at least partially transparent portion.

43. Media disc storage container as claimed in claim 38, wherein the at least partially transparent portion of the front part is bordered by the coloured material also along the first side wall and the third side wall.

44. Media disc storage container as claimed in claim 43, wherein the at least partially transparent portion of the back part is bordered by the coloured material also along the first side wall and the third side wall.

45. Media disc storage container as claimed in claim 38, wherein the coloured material of the at least one coloured portion and the second material of the one or more at least partially transparent portion cover the entire front part without holes in the material.

46. Media disc storage container as claimed in claim 38, wherein the coloured material of the at least one coloured portion and the second material of the one or more at least partially transparent portion cover the entire back part without holes in the material.

47. Media disc storage container as claimed in claim 45, wherein the coloured material of the at least one coloured portion and the second material of the one or more at least partially transparent portion cover the entire back part without holes in the material.
